(19) United States
(12) Patent Application Publication
(10) Pub. No.: US 2011/0289310 A1
(43) Pub. Date: Nov. 24, 2011

(54) Cloud computing appliance

(76) Inventors: Thomas D. Selgas, Athens, TX (US); Jonathan Cutrer, San Angelo, TX (US)

(21) Appl. No.: 13/112,931

(22) Filed: May 20, 2011

Related U.S. Application Data
(60) Provisional application No. 61/346,776, filed on May 20, 2010.

(51) Int. Cl. H04L 9/00

(52) U.S. Cl. 713/150

(57) ABSTRACT

A cloud computing appliance is provided in exemplary embodiment. The cloud computing device includes a computer server. The computer server is configured to receive a user file having a user filename and a user data content. The computer server is further configured to record an index record for the user file including the user filename and a dynamically generated storage name. The computer server is further configured to encipher the user data content with a symmetric key, encipher the symmetric key with an asymmetric key, and transmit a cloud file having a filename of the dynamically generated storage name and a data content of the enciphered user data content and the enciphered symmetric key.

### CROSS-REFERENCE TO RELATED APPLICATIONS

This application relates to, and claims the benefit of the filing date of, co-pending U.S. provisional patent application Ser. No. 61/346,776, entitled CLOUD COMPUTING APPLIANCE, filed May 20, 2010, the entire contents of which are incorporated herein by reference for all purposes.

### TECHNICAL FIELD

This application relates to cloud storage, and, more particularly, for convenient access to secure cloud storage.

### BACKGROUND

In cloud computing, a cloud may be a computer server or a collection of computer servers which provide file storage services. Typically, a user obtains cloud file storage services from a third party which owns and operates the cloud. Third party cloud storage is often desirable because it frees the user from having to maintain file storage servers. A user may store files on and retrieve files from the cloud through a computer network, usually the Internet.

The user may not trust the third party's security of the cloud, which the user may have no control over. The user has the option of taking several steps to protect the security of the user's files stored on the cloud from an intruder. First, to prevent an intruder from reading the user's files, the user may encipher, or encrypt, the data content of the files before storing them on the cloud. Second, an intruder may be able to learn sensitive information from the filenames, so the user may replace the filenames with innocuous, meaningless names that do not contain sensitive information. Third, an intruder may be able to learn sensitive information from the file path hierarchy, so the user may change the path hierarchy of the files on the cloud to a meaningless hierarchy or remove the path hierarchy altogether.

These security measures may prevent third parties from obtaining information from the files stored on the cloud, but may make the files stored on the cloud inconvenient to retrieve. The user may be unable to search the data content of the enciphered files without first deciphering the files. When the user wishes to retrieve a particular file, the user may be unable to identify the file without the original filename and path hierarchy.

It would be advantageous if a user could securely store files on a cloud while being able to view the files as though the cloud was a local mounted file system. Additionally, because a user may not have control of the cloud, it would further be desirable if this capability could be provided without modification to existing clouds. To simplify implementation, it would further be desirable if this capability could be provided without modification to existing user devices.

### SUMMARY

A cloud computing appliance is provided in exemplary embodiment. The cloud computing device includes a computer server. The computer server is configured to receive a user file having a user filename and a user data content. The computer server is further configured to record an index record for the user file including the user filename and a dynamically generated storage name. The computer server is further configured to encipher the user data content with a symmetric key, encipher the symmetric key with an asymmetric key, and transmit a cloud file having a filename of the dynamically generated storage name and a data content of the enciphered user data content and the enciphered symmetric key.

### DESCRIPTION OF DRAWINGS

For a more complete understanding of the present invention and the advantages thereof, reference is now made to the following Detailed Description taken in conjunction with the accompanying drawings, in which:

FIG. 1 depicts an exemplary environment for the operation of a cloud computing appliance;

FIG. 2 depicts an exemplary method for storing a file on a cloud;

FIG. 3 depicts an exemplary method for interacting with a cloud as a virtual local mounted file system; and

FIG. 4 depicts an exemplary method for retrieving a file from a cloud.

### DETAILED DESCRIPTION

In the following discussion, numerous specific details are set forth to provide a thorough explanation. However, such specific details are not essential. In other instances, well-known elements have been illustrated in schematic or block diagram form. Additionally, for the most part, specific details within the understanding of persons of ordinary skill in the relevant art have been omitted.

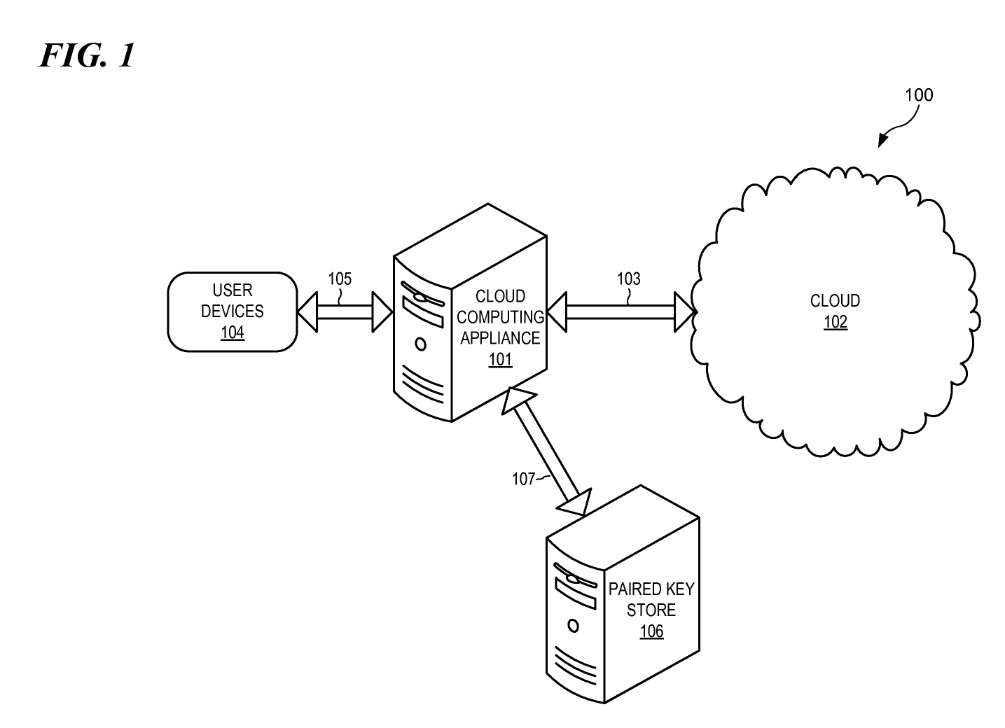

Referring to FIG. 1, depicted is an exemplary environment 100 for the operation of a cloud computing appliance 101. Cloud computing appliance 101 may store files on and retrieve files on a cloud 102 through a cloud connection 103. Cloud connection 103 may typically comprise an Internet connection.

Cloud computing appliance 101 acts as an interface to cloud 102 for one or more user devices 104. The user devices 104 may be on a local network with cloud computing appliance 101 or remotely connecting to cloud computing appliance 101 from an external network. The term “user devices” refers to the devices' use of cloud computing appliance 101. User devices 104 need not be under direct human control. User devices 104 may perform automated, scheduled storage of files on cloud 102 through a job scheduler such as cron.

User devices 104 are connected to cloud computing appliance 101 through one or more user device network connections 105. User devices 104 may use cloud computing appliance 101 to store files on cloud 102, retrieve files from cloud 102, and view the files on cloud 102 as though cloud 102 was a local mounted file system.

Cloud computing appliance 101 may use both “symmetric” and “asymmetric” cryptography keys. A symmetric key is a key which can encipher and decipher the same set of data. Asymmetric keys are generated in pairs. Each asymmetric key in a pair can encipher a set of data so that the paired key is necessary to decipher the data, or decipher data previously enciphered by the paired key. However, an asymmetric key cannot both encipher and decipher the same set of data. Once the data is enciphered by an asymmetric key, the paired asymmetric key is necessary to decipher the data.

A pair of asymmetric keys commonly consists of a public key and a private key. The public key is publicly disseminated while knowledge of the private key may be limited to a user or users the pair is assigned to. Each user of cloud computing appliance 101 may have an assigned public and private key pair used by cloud computing appliance 101 to encipher and decipher files.

These key pairs may be stored on paired key store (PKS) 106, an external remote server. Cloud computing appliance 101 may retrieve the key pairs through paired key store network connection 107. Alternately, cloud computing appliance 101 may itself contain a paired key store, eliminating the need for a separate paired key store 106 and paired key store network connection 107. A remotely located paired key store may be more expensive, but when implemented correctly may provide higher security.

All network connections to and from cloud computing appliance 101, including cloud connection 103, user device network connections 105, and paired key store network connection 107, are preferably secure virtual private network connections. Possible secure connection techniques include the Secure Sockets Layer (SSL) protocol, Pretty Good Privacy (PGP), Internet Key Exchange (IKE), and a Public Key Infrastructure (PKI).

User devices 104 and cloud 102 may have conventional file systems where data is stored as discrete files. Each file may have multiple parts, which are not necessarily stored within the file. First, a file may have a filename, which is an identifier by which the file can be referred to. Second, a file may have a path hierarchy, which uniquely identifies the location of the file. The path hierarchy may be referred to as a Uniform Resource Identifier (URI). The filename may be part of the path hierarchy. A file's path hierarchy often includes the directories containing the file. Third, a file may have various miscellaneous attributes which describe how the file is to be stored and accessed. For instance, attributes may define what users may create, read, update, and delete (CRUD) a file. Fourth, a file may have a data content in a variety of formats. The data content is typically by far the largest parts of a file, and storage of the data content in particular is usually the objective of cloud file storage.

Cloud computing appliance 101 may simulate a local mounted file system, allowing user devices 104 to search in the stored files and browse the directory structure of the stored files. When a user wishes to retrieve a file stored on cloud 102, cloud computing appliance 101 may retrieve that file, decipher and decompress the file, and add the potentially descriptive or identifying information again before sending the file to a user device 104.

The cloud computing appliance 101 receives files from user devices 104, removes potentially descriptive or identifying information from the files, compresses and enciphers the files, and transmits the files to the cloud. The information removed may include filenames, path hierarchies, properties, and attributes. Cloud computing appliance 101 may remove the information by replacing it with meaningless, arbitrary data.

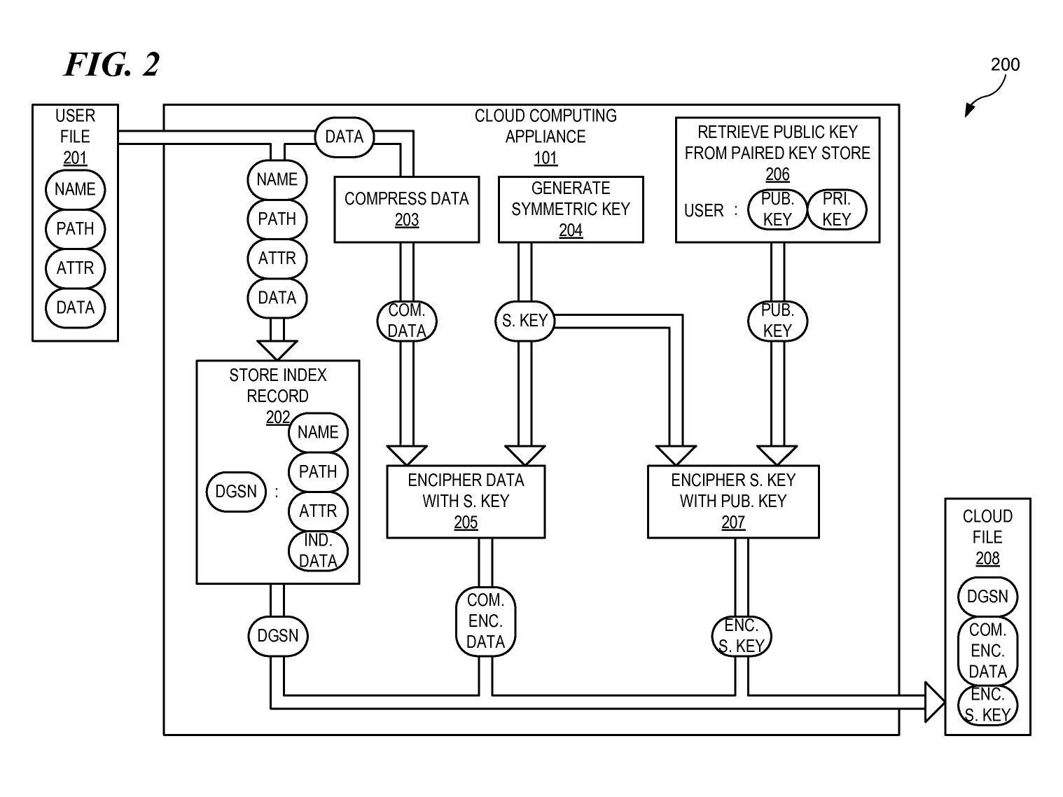

Referring to FIG. 2, depicted are the data flows in a method 200 for cloud computing appliance 101 storing a file on the cloud. Cloud computing appliance 101 receives a user file 201 from a user device. A user file may be an arbitrary insecure file which a user wishes to store on the cloud. User file 201 may have a filename, a path, attributes, and data.

At block 202, cloud computing appliance 101 may assign file 201 an arbitrary Dynamically Generated Storage Name (DGSN) and add an index record of file 201 to an index of files stored on the cloud. The DGSN may be randomly generated and serves only to distinguish the file 201 from other files stored on the cloud. The DGSN may be associated with the file's index record so the file may be identified from its DGSN. For each file, the index record may contain its name, path, and attributes. The index record may also contain an index of the file's data content. From this index of the data content, the file's data content may be searched without retrieving the complete data from the cloud.

At block 203, cloud computing appliance 101 may compress the data content of file 201. The purpose of the compression is to reduce the storage space taken by the data on the cloud. Any compression algorithm, such as Lempel-Ziv-Welch (LZW) compression, may be used.

At block 204, cloud computing appliance 101 may generate a new symmetric key for enciphering the data content of file 201. A gamma decay device is a possible source of a random seed for generating the symmetric key. At block 205 the compressed data may be enciphered with the symmetric key. Any symmetric enciphering algorithm may be used, including AES, 3DES, Blowfish, Serpent, and Twofish.

At block 206, cloud computing appliance 101 may retrieve a public asymmetric key from a paired key store. The paired key store stores the public and private keys of users who may store files on the cloud. As previously described with reference to FIG. 1, the paired key store may be part of cloud computing appliance 101 itself or an external remote server accessed through a secure connection. A gamma decay device is a possible source of a random seed for generating the asymmetric keys.

At block 207, cloud computing appliance 101 may use the public key to encipher the symmetric key used to encipher the data. Any asymmetric enciphering algorithm may be used, including RSA, Cramer-Shoup, DSS, and Diffie-Hellman. Optionally, the enciphered symmetric key may be base64 encoded.

Cloud computing appliance 101 may combine the DGSN produced in block 202, the compressed, encipher data produced in block 205, and the enciphered symmetric key produced in block 207 into a cloud file 208. Cloud computing appliance 101 may store cloud file 208 on the cloud. The DGSN may be the filename of cloud file 208. The data content of cloud file 208 may contain the compressed, enciphered user file data content and the enciphered symmetric key. If a path or attributes are necessary for cloud file 208, any arbitrary path or attributes may be used.

As stored, cloud file 208 is secure against an intruder without the secret key generated in block 204 or the private key associated with the public key retrieved in block 206. The intruder cannot read the data because it is enciphered. The DGSN and any path or attributes are arbitrary and provide the intruder with no information about the file.

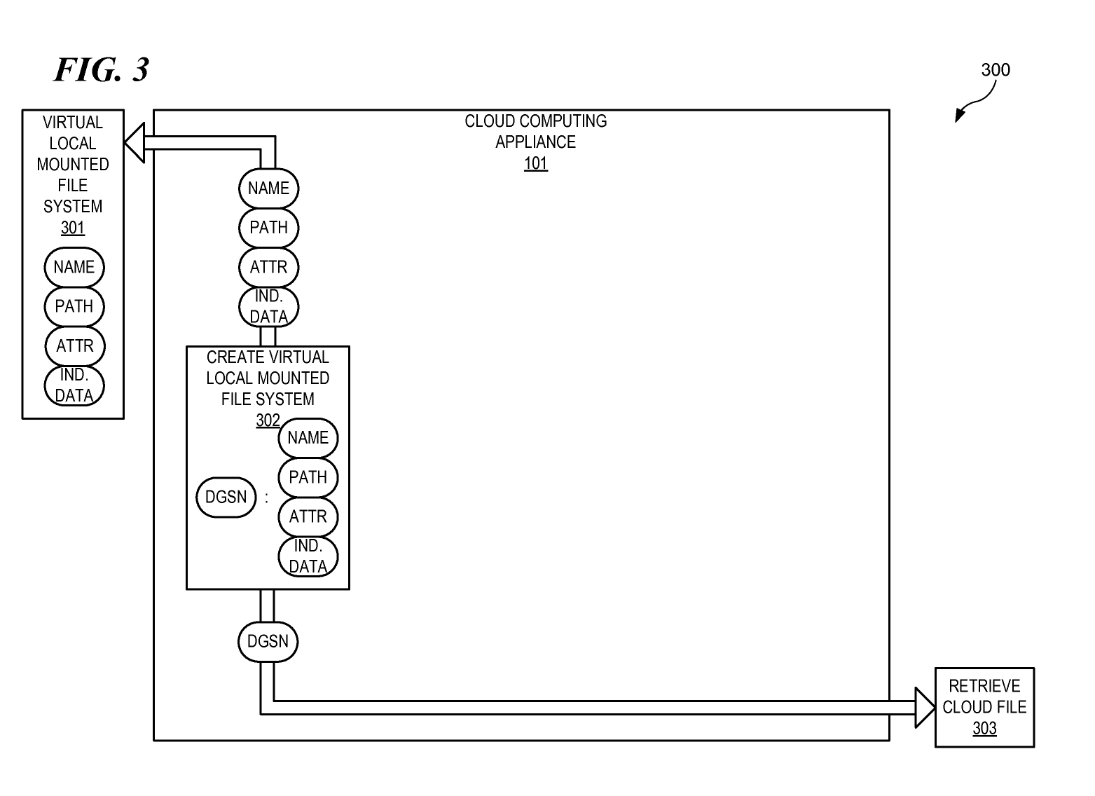

Referring to FIG. 3, depicted are the data flows in a method 300 for interacting with the cloud as a virtual local mounted file system 301. Because cloud computing appliance 101 stores an index record for every file on the cloud, at block 302 it can produce the directory structure of those files even though the directory structure does not exist on the cloud. A user may browse the files stored on the cloud as though they were stored on a local mounted file system.

Because cloud computing appliance 101 stores the name, path, and attributes of the files on the cloud, a user may rename files, move files, and change file attributes without cloud computing appliance 101 interacting with the cloud. Because cloud computing appliance 101 stores an index record for every file on the cloud, a user may also search in the files stored on the cloud as though they were stored on a local mounted file system. At block 303, when a user wishes to open a file, cloud computing appliance 101 may identify and retrieve the file by its associated DGSN.

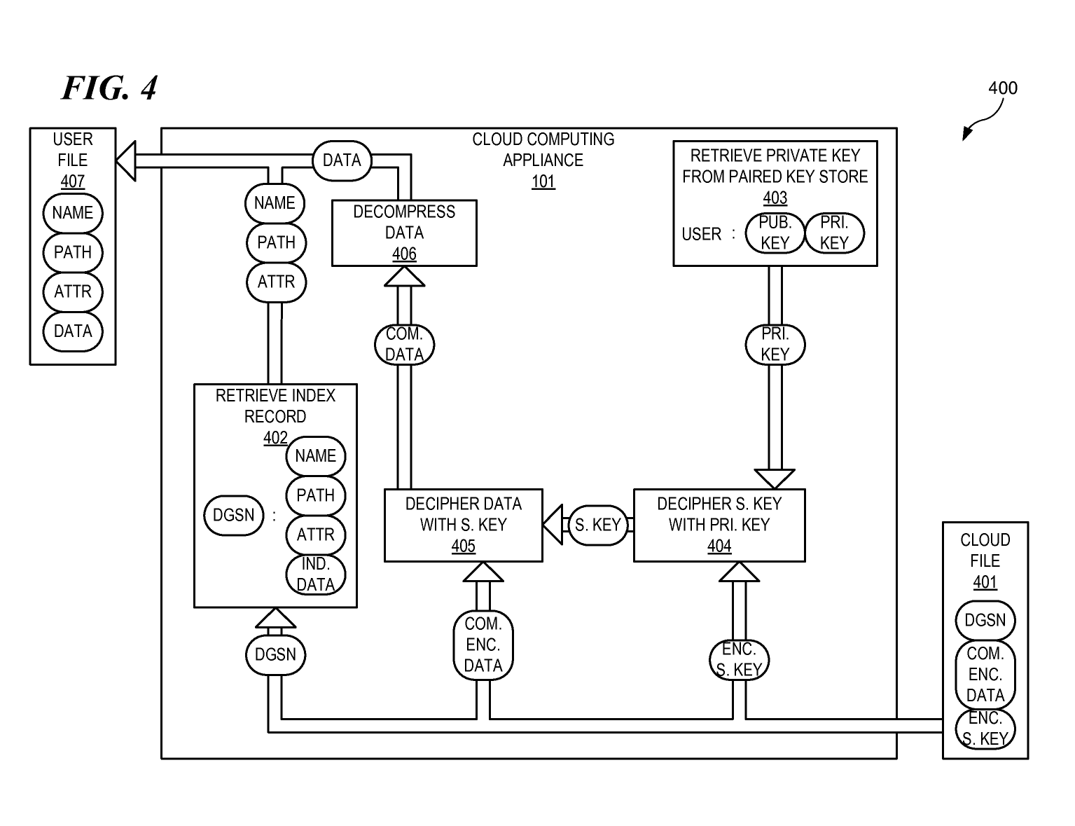

Referring to FIG. 4, depicted are the data flows in a method 400 for retrieving a file from the cloud. Cloud computing appliance 101 receives a cloud file 401 from the cloud. At block 402, cloud computing appliance 101 may retrieve an index record with the name, path, and attributes of the file from an index record having with the DGSN of the cloud file 202. At block 403, cloud computing appliance 101 may retrieve the private asymmetric key associated with the public key used to encipher the symmetric key.

At block 404, cloud computing appliance 101 may use the private key to decipher the symmetric key. If the symmetric key was base64 encoded, the symmetric key may be first base64 decoded. At block 405, cloud computing appliance 101 may decipher the compressed data with the symmetric key. At block 406, cloud computing appliance 101 may decompress the data.

Cloud computing appliance 101 may combine the filename, path, and attributes produced in block 402 and the data produced in block 406 into a user file 407. User file 407 may be reconstructed exactly as it was stored. Cloud computing appliance 101 has therefore taken advantage of the file storage capabilities of the cloud without potentially exposing sensitive information in user file 407 to an intruder in the cloud.

The operations of cloud computing appliance 101 may be implemented in a file system driver for a protocol such as Network File System (NFS), Common Internet File System (CIFS), Server Message Block (SMB), or Andrew File System (AFS). Cloud computing appliance 101 may appear to user devices as a local mounted file system, and the user devices may store files on, retrieve files from, browse, and search the files on the cloud as they would any other local mounted file system. Likewise, because cloud computing appliance 101 sends complete files to the cloud, the cloud may receive and store the secure cloud files as it would any other files.

Additional operations of cloud computing appliance 101 may include file creation, deletion, updating, overwriting, and copying. File creation may be performed in the same manner as file storage, but with an empty file to store. File deletion may be accomplished by deleting the file on the cloud having the DGSN and deleting the index record for the file in the index of cloud computing appliance 101.

File updating and overwriting may be performed by deleting the existing file on the cloud and storing a new file. Optionally, the previous file's DGSN may be re-used for the updated or overwriting file. File copying may be accomplished by associating a copy of the cloud computing appliance's index record for the file with a new DGSN and copying the original cloud file to a cloud file with the new DGSN.

The above discussion describes an embodiment where a cloud computing appliance is interposed between a user device and the cloud. In an alternate embodiment, the functions of the cloud computing appliance may be performed by a user device. In this embodiment, the user device may execute software instructions which cause the user's computer to perform the functions of a cloud computing appliance.

A cloud computing appliance may be produced as a specialized device hard-wired to only perform the operations described above. Alternately, a cloud computing appliance may be produced by providing a general purpose computer processor with instructions for performing the operations described above and causing the computer processor to execute the instructions. The instructions may be provided on a non-transitory computer-readable medium.

It is noted that the embodiments disclosed are illustrative rather than limiting in nature and that a wide range of variations, modifications, changes, and substitutions are contemplated in the foregoing disclosure and, in some instances, some features may be employed without a corresponding use of the other features. Many such variations and modifications may be considered desirable by those skilled in the art based upon a review of the foregoing description of various embodiments.

1. A cloud computing appliance comprising a computer server configured to:
receive a user file comprising:
a filename comprising a user filename; and
a data content comprising a user data content;
record an index record for the user file, the index record comprising:
the user filename; and
a dynamically generated storage name;
encipher the user data content with a symmetric key;
encipher the symmetric key with an asymmetric key; and
transmit, over a network connection, a cloud file comprising:
a filename comprising the dynamically generated storage name; and
a data content comprising the enciphered user data content and the enciphered symmetric key.

2. The cloud computing appliance of claim 1, wherein:
the user file further comprises a path and one or more attributes; and
the index record further comprises the path and the one or more attributes.

3. The cloud computing appliance of claim 1, wherein:
the index record further comprises an index of the user data content; and
the computer server is further configured to search the index of the user data content without accessing the cloud file.

4. The cloud computing appliance of claim 1, wherein:
the computer server is further configured to compress the data content; and
the enciphered user data content comprises enciphered compressed user data content.

5. The cloud computing appliance of claim 1, wherein the computer server is further configured to generate the symmetric key.

6. The cloud computing appliance of claim 1, wherein the computer server is further configured to retrieve the asymmetric key from a paired key store.

7. The cloud computing appliance of claim 1, wherein the asymmetric key comprises a public key.

8. The cloud computing appliance of claim 1, wherein the computer server is further configured to simulate the storage of the user file on a local mounted file system.

9. A cloud computing appliance comprising a computer server configured to:
receive, over a network connection, a cloud file comprising:
a filename comprising a dynamically generated storage name; and
a data content comprising an enciphered user data content and an enciphered symmetric key;
retrieve an index record comprising:
a user filename; and
the dynamically generated storage name;
decipher the enciphered symmetric key with an asymmetric key;
decipher the enciphered user data content with the symmetric key; and
create a user file comprising:
a filename comprising the user filename; and
a data content comprising the user data content.

10. The cloud computing appliance of claim 9, wherein:
the index record further comprises a path and one or more attributes; and
the user file further comprises the path and the one or more attributes.

11. The cloud computing appliance of claim 9, wherein:
the enciphered user data content comprises enciphered compressed user data content; and
the computer server is further configured to decompress the compressed user data content.

12. The cloud computing appliance of claim 9, wherein the computer server is further configured to retrieve the asymmetric key from a paired key store.

13. The cloud computing appliance of claim 9, wherein the asymmetric key comprises a private key.

14. The cloud computing appliance of claim 9, wherein the computer server is further configured to simulate access to the user file on a local mounted file system.

15. A computer program product for cloud computing, the computer program product embodied on a non-transitory computer-readable medium, the computer program product comprising:
computer code for receiving a user file comprising:
a filename comprising a user filename; and
a data content comprising a user data content;
computer code for recording an index record for the user file, the index record comprising:
the user filename; and
a dynamically generated storage name;
computer code for enciphering the user data content with a symmetric key;
computer code for enciphering the symmetric key with an asymmetric key; and
computer code for transmitting, over a network connection, a cloud file comprising:
a filename comprising the dynamically generated storage name; and
a data content comprising the enciphered user data content and the enciphered symmetric key.

16. The computer program product of claim 15, wherein:
the user file further comprises a path and one or more attributes; and
the index record further comprises the path and the one or more attributes.

17. The computer program product of claim 15, wherein:
the index record further comprises an index of the user data content; and further comprising:
computer code for searching the index of the user data content without accessing the cloud file.

18. The computer program product of claim 15, further comprising:
computer code for compressing the data content; and wherein
the enciphered user data content comprises enciphered compressed user data content.

19. The computer program product of claim 15, further comprising computer code for generating the symmetric key.

20. The computer program product of claim 15, further comprising computer code for retrieving the asymmetric key from a paired key store.

21. The computer program product of claim 15, wherein the asymmetric key comprises a public key.

22. The computer program product of claim 15, further comprising computer code for simulating the storage of the user file on a local mounted file system.

23. A computer program product for cloud computing, the computer program product embodied on a non-transitory computer-readable medium, the computer program product comprising:
computer code for receiving, over a network connection, a cloud file comprising:
a filename comprising a dynamically generated storage name; and
a data content comprising an enciphered user data content and an enciphered symmetric key;
computer code for retrieving an index record comprising:
a user filename; and
the dynamically generated storage name;
computer code for deciphering the enciphered symmetric key with an asymmetric key;
computer code for deciphering the enciphered user data content with the symmetric key; and
computer code for creating a user file comprising:
a filename comprising the user filename; and
a data content comprising the user data content.

24. The computer program product of claim 23, wherein:
the index record further comprises a path and one or more attributes; and
the user file further comprises the path and the one or more attributes.

25. The computer program product of claim 23, wherein:
the enciphered user data content comprises enciphered compressed user data content; and
further comprising computer code for decompressing the compressed user data content.

26. The computer program product of claim 23, further comprising computer code for retrieving the asymmetric key from a paired key store.

27. The computer program product of claim 23, wherein the asymmetric key comprises a private key.

28. The computer program product of claim 23, further comprising computer code for simulating access to the user file on a local mounted file system.

29. A cloud computing appliance comprising a computer server configured to:
receive, from a secure network connection to a user device, a user file comprising:
a filename comprising a user filename;
a path comprising a user path;
one or more attributes comprising one or more user attributes; and
a data content comprising a user data content;
record an index record for the user file, the index record comprising:
the user filename;
the user path;
the one or more user attributes;
an index of the user data content; and
a dynamically generated storage name;
compress the user data content;
generate a symmetric key;
encipher the compressed user data content with the symmetric key;
retrieve a public asymmetric key from a secure network connection to a paired key store;
encipher the symmetric key with the public asymmetric key;
transmit, over a secure network connection to a cloud, a cloud file comprising:
a filename comprising the dynamically generated storage name; and
a data content comprising the enciphered compressed user data content and the enciphered symmetric key;
simulate, to the user device, the cloud as a local mounted file system;
search the index of the user data content without accessing the cloud file;
receive, from the secure network connection to the user device, a request to access the user file;
request the cloud file on the cloud by the digitally generated storage name;
receive, from the network connection to the cloud, the cloud file;
retrieve the index record by the dynamically generated storage name;
retrieve a private asymmetric key from the secure network connection to the paired key store;
decipher the enciphered symmetric key with the private asymmetric key;
decipher the enciphered compressed user data content with the symmetric key;
decompress the compressed user data content; and
reconstruct the user file, the reconstructed user file comprising:
a filename comprising the user filename;
a path comprising the user path;
one or more attributes comprising the one or more user attributes; and
a data content comprising the user data content;
transmit, over the secure network connection to the user device, the reconstructed user file.
